(19) United States
(12) Patent Application Publication
(10) Pub. No.: US 2011/0135702 A1
(43) Pub. Date: Jun. 9, 2011

(54) SPORICIDAL COMPOSITION FOR CLOSTRIDIUM DIFFICILE SPORES

(76) Inventors: Douglas R. Hoffman, Greenville, WI (US); Aimin He, Alpharetta, GA (US); David W. Koenig, Menasha, WI (US); Andrea J. Smiltneek, Madison, WI (US); DaeGun Kim, Yongin-si (KR); YoungSook Kim, GyeongGi-Do (KR)

(21) Appl. No.: 12/633,883

(22) Filed: Dec. 9, 2009

(51) Int. Cl. A01N 25/08; A01N 59/16; A01N 59/20; A01N 59/08; A01N 37/52; A01N 33/12; A01N 31/14; A01N 31/00; A01P 1/00

(52) U.S. Cl. 424/409; 424/617; 424/618; 424/630; 424/661; 514/635; 514/642; 514/721; 514/724

(57) ABSTRACT

A cleaning medium or formulation that contains a sporicidal composition is described. The composition includes about 0.1-20% weight/weight of a germinant agent, about 0.01-75% w/w of an antimicrobial agent, in terms of dry or wet total weight, and which is admixed with water to generate a solution with a pH of 3.5-9.5. The composition can help trigger the germination of spores, in particular C. difficile, and subsequently deactivate or kill the spores. A means of applying the cleaning formulation in a medium and process for cleaning are also described.

### FIELD OF INVENTION

The present invention relates to a cleaning medium that includes a sporicidal chemical formulation. In particular, the invention pertains to a composition that can help trigger the germination of spores, and subsequently deactivate or kill the spore. A means of applying the cleaning formulation in a medium is also described.

### BACKGROUND

Spore forming Clostridium difficile associated diseases (CDAD) remain an important nosocomial infection associated with significant morbidity and mortality. In recent years, the incidence of infection by this condition has unfortunately increased and high rates of recurrent disease continue with currently available treatment regimens. Typically, Clostridium difficile is transmitted by the fecal-oral route. Spores that persist in the environment survive the gastric acid barrier and germinate in the colon. Toxins released from vegetative C. difficile cells are responsible for clinical CDAD.

As a spore former, C. difficile is more difficult to eradicate than other bacteria because of its dormant spore state. Although vegetative C. difficile can only survive 15 minutes aerobically, they are resilient because they form spores. C. difficile spores can be found as airborne particles, attached to inanimate surfaces such as hard surfaces and fabrics, and animate surfaces such as skin and hair. Spores can be found on the patient's skin as well as any surface in the room that the infected patient occupied. During exams these spores can be transferred to the hands and body of healthcare workers and therefore spread to all subsequent equipment and areas they contact.

Hospital discharges for CDAD in the United States doubled between 1996 and 2003. These nosocomial infections are extremely costly to hospitals at $1.28 to $9.55 billion annually in the U.S. alone, mostly due to infected patients requiring extended stays of 3.6 to 14.4 days. Complications of CDAD include life-threatening diarrhea, pseudo-membranous colitis, toxic megacolon, sepsis, and death. Expenses related to treatment of these conditions ranges from $3,669 to $27,290 per patient. CDAD causes death in 1-2% of affected patients.

People are most often infected in hospitals, nursing homes, or institutions, although C. difficile infection in the community, outpatient setting is increasing. C. difficile infection (CDI) can range in severity from asymptomatic to severe and life-threatening, especially among the elderly. The rate of C. difficile acquisition is estimated to be 13% in patients with hospital stays of up to 2 weeks, and 50% in those with hospital stays longer than 4 weeks.

While currently available antibiotics used for treatment of recurrent CDAD lead to symptomatic improvement, they are ineffective against C. difficile spores, the transmissible form of the disease. This causes a high risk of relapse occurring post-therapy as sporulated microorganisms begin to germinate. Therefore, controlling C. difficile infection requires limiting the spread of spores by good hygiene practices, isolation and barrier precautions, and environmental cleaning.

Because of the prevalence of C. difficile in hospitals, healthcare workers and researchers have an interest in developing a sporicidal agent that can kill C. difficile and its spores. Currently, harsh chemicals have been used, such as bleach, alkyating agents, and acids to kill spores on surfaces. These commercial technologies are not appealing due to their high carcinogenic and corrosive nature. Therefore, a need exists to develop an alternative chemical composition that is as effective as current sporicidal agents but is gentle on the skin and to the environment. Mixing a skin safe biocide with a germinant may meet this need.

Bile salts have been reported to significantly increase spores recovery from environmental surfaces and stool. Recent in vitro studies showed that sodium taurocholate and glycine were cogerminants for C. difficile spore germination. A new sporicidal formulation containing germinants that can be incorporated into a cleaning solution can greatly enhance the control of C. difficile spores. The cleaning solution, associated supplies, and/or cleaning techniques can benefit sanitation workers in their efforts to maintain a germ-free environment when cleaning possible contaminated surfaces.

### SUMMARY OF THE INVENTION

The present invention, in part, pertains to a cleaning formulation, solution, or dry powder that contains a sporicidal composition comprising: about 0.1-20% weight/weight (% w/w) of a spore germinant agent, about 0.01-70% or 75% w/w of an antimicrobial agent, in terms of wet or dry total weight, and which can be mixed with water to generate a solution with a pH of 3.5-8.5 or 9.5. This synergistic composition appears to trigger germination, either concurrently or sequentially with spore inactivation. When bacterial spores are exposed to a suitable germinant which triggers the initiation of germination, they are significantly more susceptible to antimicrobials.

### DETAILED DESCRIPTION OF THE INVENTION

Clostridium difficile, also known as “CDF/cdf”, or “C. diff”, a species of Gram-Positive, spore-forming anaerobic bacillus, can lead to severe complications ranging from antibiotic-associated diarrhea (AAD) to severe life-threatening pseudomembranous colitis, a severe infection of the colon. In fact, C. difficile is the cause of approximately 25% of all cases of antibiotic-associated diarrhea. Most cases of C. difficile associated disease (CDAD) occur in hospitals or long-term care facilities causing more than 300,000 cases per year in the United States alone. The total US hospital costs for CDAD management have been estimated to be $3.2 billion per year.

Clostridia are motile bacteria that are ubiquitous in nature and are especially prevalent in soil. Under microscopy, clostridia appear as long drumstick-like irregularly-shaped cells with a bulge at their terminal ends. Clostridium difficile cells show optimum growth on blood agar at human body temperatures in the absence of oxygen. When stressed, the bacteria produce spores, which tolerate extreme conditions that the active bacteria cannot tolerate.

In small numbers, C. difficile do not result in significant disease. The first step in development of C. difficile colonization is the disruption of the normal flora of the colon, usually by antibiotics. Antibotic treatments, especially those with a broad spectrum of activity, cause disruption, often resulting from eradication of the normal intestinal flora by antibiotics of normal intestinal flora, leading to an overgrowth of C. difficile. C. difficile is currently the most common cause of nosocomial diarrhea with significant morbidity and mortality. The C. difficile bacteria, which naturally reside in the human intestines, overpopulate and release toxins that can cause bloating, constipation, or diarrhea with abdominal pain, which may become severe. Latent symptoms often mimic some flu-like symptoms.

Antibiotic treatment of C. difficile infections can be difficult, due both to antibiotic resistance as well as physiological factors of the bacteria itself. Because the organism forms acid and heat-resistant spores, C. difficile spores can persist in the environment for years and contamination by C. difficile is very common in hospital, clinical, long-term care or nursing home environments. Often, it can be cultured from almost any surface in a hospital. Patient-to-patient transmission of C. difficile spores occurs by sharing the medical equipments or facilities in hospitals, nursing homes, and other extended-care facilities. Typically, C. difficile is transmitted from person to person by the fecal-oral route. Ingested spores of C. difficile survive the gastric acid barrier and germinate in the colon. Vegetative cells release two potent toxins that ultimately mediate diarrhea and colitis.

Given the pathogenesis of C. difficile, judicious use of antibiotics and strict infection control and environmental measures are keys to the prevention of disease. The implementation of antibiotic stewardship programs has been associated with decreased incidence of CDAD. To prevent spread of spores, environmental cleaning and patient isolation are needed. Several disinfectants commonly used in hospitals may be ineffective against C. difficile spores, and may actually promote spore formation. However, disinfectants containing bleach are effective in killing the organisms.

Health care workers should avoid of using alcohol hand rubs, especially in outbreak settings, because alcohol is not effective at killing clostridia spores. Due to their resistant nature, spores are very difficult to be eliminated with standard measures. Consumer and health care applications are taking extreme approaches with harsh chemicals including aldehydes and highly reactive oxidizing agents which are either carcinogenic or corrosive. It would be virtually impossible to use current technologies on skin and delicate devices. There is a need to develop a disinfectant that is nonreactive to untargeted materials and nonharmful to humans and environment.

### Section I—Sporicidal Composition

The present invention, in part, describes a sporicidal composition that is effective against C. difficile spores. The composition contains at least two major components, desirably at least three: a) a C. difficile specific germinant which binds to the germination receptor to initiate spore germination; b) a surfactant which may facilitate transport of biocide and/or germinant across the membrane; and c) a biocide which inactivates the spore by multiple mechanisms, such as either disrupting membranes or inactivating essential cellular functions. It is believed that as soon as germination is triggered, water influx and Ca⁺²-dipicolinate release from the spore core takes place. An increased exchange of flow in and out of spores coat may facilitate transport of surfactant and biocide through spore cortex. These three components may work together to deliver synergistic sporicidal effects.

The sporicidal composition includes, on a dry or wet weight basis, about 0.1-17% or 20% weight/weight of a germinant agent, about 0.01-65% w/w, or 70% or 75% w/w of an antimicrobial agent, and which can be mixed with water to generate a solution with a pH of 3.5-9.5, desirably about pH 4 or 5-8.0, 8.5 or 9.0. The germinant agent can be present in an amount from about 1.0, 2.0%, or 3.5% w/w to about 15%, 18%, or 20% w/w, and the antimicrobial agent is present in an amount from about 0.1%, 0.5%, or 1% w/w to about 60% or 62% w/w. The composition may further include up to about 8%, 10% or 12% w/w of a protein denaturant, up to about 8%, 10%, or 12% w/w of a surfactant, up to about 23% or 25% w/w of a reducing agent, and/or up to about 1.5% or 2% w/w of an electron transport accelerator. The protein denaturant can be present in an amount from about 0.1%, 0.5%, or 1% w/w to about 7%,8%, 9.0% or 10% w/w. The surfactant can be present in an amount from about 0.5%, 0.7% or 1% w/w to about 7% or 8.7% w/w. When dissolved in an aqueous or polar organic solvent, the active concentrations of the active ingredients may range from 0.1-95% w/w, including all ingredients. Typically, the range may be from about 0.5%, 1%, 1.5% or 2.5% w/w to about 70%, 75%, 80% or 85% w/w, inclusive of all permutations and combinations thereinbetween.

The germinant agent, for example, can be one of the following: sodium taurocholate, glycocholate, cholate, glycine, or a combination thereof. The antimicrobial agent, for instance, can be one of the following: an alcohol, quaternary ammonium compounds, biguanides, triclosan, peroxides, hypochlorites, hypochlorous acid, iodine, silver, copper, isothiazalones, short-chain acids, or a combination thereof. The protein denaturant, for example, can be one of the following: urea, sodium lauryl sulfate, guanidine hydrochloride, ethylene-diamine tetra-acetic acid, acetic acid, alcohol, aldehydes, tris(2-carboxyethyl)phosphine, or a combination thereof. The surfactant, for instance, can be one of the following: anionic, cationic, non-ionic, and amphoteric, or a combination thereof. The reducing agent, for instance, can be one of the following: sodium thioglycollate, cysteine, zinc, copper, nickel, magnesium, manganese, ferrous iron, sulfite compounds, di-isobutylaluminum hydride, alcohols, sugar alcohols, titanium, amorphous ferrous sulfide, sodium borohydride, lycopene, and vitamin E. The electron transport accelerator, for example, can be one of the following: phenazine methosulfate, phenazine ethosulfate, 7-hydroxycoumarin, vanillin, p-hydroxybenzenesulfonate, and methylene blue.

The sporicidal composition exhibits at least a 90% reduction of live Clostridium difficile spores within about 10-15 minutes of application of said cleaning medium to a spore-contaminated surface. In desirable embodiments, the sporicidal composition can be at least 90% efficient at reducing live C. difficile spores within about 1 minute of application to a spore-contaminated surface. If the antimicrobial agent is an alcohol, its concentration should be >62% w/w of dry or wet total weight.

### Section II—Cleaning Substrate

In another aspect, the present invention relates to a wiper or sheet. The wiper has a substrate sheet; a sporicidal composition disposed over or within at least part of said sheet, said sporicidal composition containing about 0.1-18% or 20% w/w of a germinant agent, about 0.01-70% or 75% w/w of a antimicrobial agent, in terms of dry or wet total weight, optionally up to about 10% w/w of a protein denaturant, up to about 10% w/w of a surfactant, up to about 25% w/w a reducing agent, and/or up to about 2% w/w of an electron transport accelerator with water to generate a solution with a pH of 3.5-8.5. Other ingredients, such as reducing agent or electron transporter, may also be included.

Furthermore, it is possible to likewise incorporate a dry formulation into or on a wipe, to deliver sporicidal actives to skin or other surface that has been pre-wetted. The wiper substrate sheet can be formed from either a cellulose-based material or nonwoven web. In particular, the substrate sheet can be formed with a material selected from at least one of the following: a cellulose-based fibrous tissue, a meltblown, hydroknit, coform, or spunlace nonwoven, or a combination of cellulose and synthetic polymer fibers. The wiper substrate also can exhibit a spore population kill rate of at least 90% or 1 Log₁₀, within about 15 minutes (typically within about 10 minutes, or desirably under about 5-7 minutes) of when said wiper is applied to a spore-contaminated surface.

Alternatively, a dry wipe impregnated with the composition described herein could be utilized as well. Water can then be added to wipe upon use of the product to activate the cleaning formulation. For example, upon dispensing from a package, one could wet or immersed a wipe sheet in water and then used it to clean the desired surface. Alternatively, the surface desired to be cleaned can be sprayed or pre-treated with water prior to cleaning with the wipe.

Wiper embodiments may have substrate materials that are selected from either woven or nonwoven fabrics. Woven fabrics may be made from natural fibers (e.g., cellulose, cotton, flax linen, hemp, jute, wool, silk) or a blend of natural and synthetic fibers (e.g., thermoplastics, polyolefin, polyester, nylon, aramide, polyacrylic materials). A wide variety of elastic or non-elastic thermoplastic polymers may be used to construct nonwoven substrate materials. For example, without limitation, polyamides, polyesters, polypropylene, polyethylene, copolymers of ethylene and propylene, polylactic acid and polyglycolic acid polymers and copolymers thereof, polybutylene, styrenic co-block polymers, metallocene-catalyzed polyolefins, preferably with a density of less than 0.9 gram/cm³, and other kinds of polyolefins, for the production of various types of elastic or non-elastic fibers, filaments, films or sheets, or combinations and laminates thereof.

One may use a wipe sheet to clean various different kinds of surfaces either in a clinical or other type of setting. These may include, for instance, various desk, table or countertops or other parts of furniture surfaces, bath and lavatory surfaces, floor and wall surfaces, medical instruments or devices, or even human skin or bedding and linens. In a liquid form, the present composition may be employed in bath or rinse to wash medical instruments, linens, bedclothes, or human skin. One may even incorporate use the formulation in a disinfecting or sanitary solution to wash hands or medical instruments.

According to the invention, we envision that one could use heat and/or sonication as part of the spore inactivation process. A heated wet wipe or a sponge may be employed in conjunction with an ultrasonic device during the cleaning process. The heating element and/or sonication device either may be integrated as part of the wipe or sponge cleaning tools, or can be separate stand-alone or secondary devices. Furthermore, an ultrasonic device can be used to enhance the inactivation process alone, without heat. Each of the two processes may be beneficial independently or combined. In an embodiment, a heater may be activated to raise the temperature of the wipers in a wipes container before use, or one may incorporate exothermic ingredients that warm the wipe upon use. For instance, some ingredients may be exothermically activated when interacting by friction against the surface to be cleaned or by microwave irradiation. Some exothermic materials may include, for example, oxidized iron powder, electrolyte salts (e.g., magnesium chloride), electrical sources, infrared, and microwave radiation. Some heating agents may be microencapsulated to increase their stability during processing and prior to use.

In certain embodiments, the sporicidal compositions can be applied topically to the external surfaces of nonwoven web filaments after they are formed. Desirably, a uniform coating is applied over the filament substrate surfaces. A uniform coating refers to a layer of the formulation that does not aggregate only at selected sites on a substrate surface, but has a relatively homogeneous or even distribution over the treated substrate surface. Desirably, the processing aid should evaporate or flash off once the cleaning composition dries on the substrate surface. Suitable processing aids may include alcohols, such as hexanol or octanol. Note that the terms “surface treatment,” “surface modification,” and “topical treatment” refer to an application of the present formulations to a substrate and are used interchangeably, unless otherwise indicated.

Nonwoven fabrics that are treated with a coating of the present invention can be fabricated according to a number of processes. According to an embodiment, the present composition can be applied to the material substrate via conventional saturation processes such as a so-called “dip and squeeze” or “padding” technique. The “dip and squeeze” or “padding” process can coat both sides of and/or through the bulk of the substrate with the sporicidal composition. When dipped in a bath, the formulation can be a unitary medium containing all components, or in subsequent multiple step processing, other desired components may be later added to the base layer. On substrates containing polypropylene, an antistatic agent can help dissipate static charge build-up from mechanical friction. An antistatic agent can be added to the sporicidal solution, and the mixture can be introduced simultaneously to the material substrate in one application step. Alternatively, the antistatic solution can be applied using a spray after the sporicidal formulation in a second step. In certain product forms, where one wishes to treat only a single side and not the inner layers or opposing side of the sheet substrate, in which the substrate material is layered to another sheet ply (e.g., filter or barrier media) that is without the sporicidal treatment, other processes are preferred such as at rotary screen, reverse roll, Meyer-rod (or wire wound rod), Gravure, slot die, gap-coating, or other similar techniques, familiar to persons in the nonwoven textile industry. (See, for example, detailed descriptions of these and other techniques are available from Faustel Inc., Germantown, Wis. (www.faustel.com).) Also one may consider printing techniques such as flexographic or digital techniques. Alternatively one may use a combination of more than one coating to achieve a controlled placement of the treatment composition. Such combination may include, but not limited to, a reverse Gravure process followed by a Meyer rod process. Alternatively, the composition may be applied through an aerosol spray on the substrate surface. The spray apparatus can be employed to apply the antimicrobial cleaning solution and/or antistatic agent only on one side of the substrate sheet or on both sides separately if desired.

### Section III—EXAMPLES

The following describes a protocol for determining the killing efficacy of the present cleaning formulation or medium.

### Procedure:

1. Prepare a spore suspension of C. difficile to 10⁵ to 10⁷ CFU/ml in Phosphate Buffered Saline (PBS).
2. Add 100 μl of spore culture to sterile vial containing 900 μl of test solution and vortex.
3. At the desired time point, vortex the vials.
4. Add 100 μl of test solution and spore mixture to sterile tubes containing 900 μl of neutralizer.
5. Place the neutralized samples in a sonicating water bath for five cycles of 1 minute on, 1 minute off.
6. Vortex each tube and pipette 100 μl of the solution on BHI+0.15% sodium taurocholate media plates (prepared in lab according to dehydrated powder instructions).
7. Prepare a control sample by adding the spore culture to 900 μl of PBS and repeat steps 3-6 above.
8. Place plates in anaerobic jars or boxes or in an anaerobic chamber and incubate for 48±4 hours at 37±3° C.
9. After incubation, enumerate colonies and record results. Calculate Log₁₀ reduction by comparing the number of colonies recovered from the test solution versus those recovered with the control.
   The results summarized in the following Examples demonstrated that antimicrobial agents alone or in combination with a surfactant had little effect on inactivating C. difficile spores. However, when in combination with a germinant(s), one observed synergistic sporicidal efficacy. Additionally, a similar synergistic effect may be possible via the combination of a germinant(s), surfactant(s), reducing agent(s), electron transport accelerator(s), and protein denaturant(s).

TABLE 1
Efficacy of example compositions containing a germinant
(sodium taurocholate), a biocide (lauryl amine oxide),
and/or a surfactant (polysorbate 80) against C. difficile
spores following a 4 minute exposure time.

| | | LOG reduction |
|---|---|---|
| Examples | Composition | from control |
| #1 | 10% sodium taurocholate | 0.05 |
| #2 | 2% lauryl amine oxide | 0.05 |
| #3 | 8% polysorbate 80 + 10% sodium | 0.01 |
| | taurocholate | |
| #4 | 2% lauryl amine oxide + 8% polysorbate 80 | 0.01 |
| #5 | 2% lauryl amine oxide + 10% sodium | 1.30 |
| | taurocholate | |
| #6 | 2% lauryl amine oxide + 8% polysorbate | 1.30 |
| | 80 + 10% sodium taurocholate | |

TABLE 2
Efficacy of example compositions containing a germinant
(sodium taurocholate and/or glycine) and/or a biocide (chlorhexidine
gluconate or Triclosan ®) against C. difficile spores
following a 1 and 4 minute exposure time.

| | | LOG reduction | |
|---|---|---|---|
| | | from control | |
| Examples | Composition | 1 minute | 4 minutes |
| #7 | 1% sodium taurocholate | 0.18 | 0.22 |
| #8 | 0.6% chlorhexidine gluconate | 0.23 | 0.25 |
| #9 | 1% sodium taurocholate + 0.6% | 0.04 | 0.02 |
| | chlorhexidine gluconate | | |
| #10 | 0.2% Triclosan ® | 0.05 | 0.00 |
| #11 | 1% sodium taurocholate + 0.2% | 0.27 | 0.38 |
| | Triclosan ® | | |
| #12 | 1% sodium taurocholate + 0.2% | 0.41 | 0.45 |
| | glycine + 0.2% Triclosan ® | | |

TABLE 3
Efficacy of example compositions containing a germinant (sodium
taurocholate and/or glycine) and/or a biocide (ethanol) against
C. difficile spores following a 1 minute exposure time.

| | | LOG reduction |
|---|---|---|
| Examples | Composition | from control |
| #13 | 0.1% sodium taurocholate | 0.04 |
| #14 | 0.5% sodium taurocholate | 0.11 |
| #15 | 1.0% sodium taurocholate | 0.05 |
| #16 | 2.0% sodium taurocholate | 0.09 |
| #17 | 70% ethanol | 0.10 |
| #18 | 0.1% sodium taurocholate + 70% ethanol | 0.12 |
| #19 | 0.5% sodium taurocholate + 70% ethanol | 0.58 |
| #20 | 1.0% sodium taurocholate + 70% ethanol | 0.40 |
| #21 | 2.0% sodium taurocholate + 70% ethanol | 0.48 |
| #22 | 2.0% sodium taurocholate + 70% ethanol + | 0.42 |
| | 0.2% glycine | |

TABLE 4
Efficacy of an example composition containing a germinant (sodium
taurocholate), a surfactant (potassium laureth phosphate), a
protein denaturant (urea), and magnesium sulfate (a hypothesized
germinant for other types of sporulating bacteria) against C. difficile
spores following a 4 minute exposure time.

| | | LOG reduction |
|---|---|---|
| Example | Composition | from control |
| #23 | 1% sodium taurocholate + 2% potassium | 0.90 |
| | laureth phosphate + 10% urea + 0.1% | |
| | magnesium sulfate | |

The present invention has been described in general and in detail by way of examples. Persons of skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein.

We claim:

1. A cleaning medium or formulation containing a sporicidal composition comprising: about 0.1-20% weight/weight of a germinant agent, about 0.01-75% w/w of an antimicrobial agent, in terms of dry or wet total weight, and which is admixed with water to generate a solution with a pH of 3.5-9.5.

2. The cleaning medium according to claim 1, wherein said germinant agent is present in an amount from about 1.0% w/w to about 18% w/w, and said antimicrobial agent is present in an amount from about 0.1% w/w to about 62% w/w.

3. The cleaning medium according to claim 1, wherein said germinant agent is one of the following: sodium taurocholate, glycocholate, cholate, glycine, or a combination thereof.

4. The cleaning medium according to claim 1, wherein said antimicrobial agent is one of the following: an alcohol, quaternary ammonium compounds, biguanides, triclosan, peroxides, hypochlorites, hypochlorous acid, iodine, silver, copper, isothiazalones, short-chain acids, or a combination thereof.

5. The cleaning medium according to claim 1, wherein said composition may further include up to about 10% w/w of a protein denaturant.

6. The cleaning medium according to claim 1, wherein said composition may further include up to about 10% w/w of a surfactant.

7. The cleaning medium according to claim 4, wherein said protein denaturant is present in an amount from about 0.1% w/w to about 9.0% w/w.

8. The cleaning medium according to claim 5, wherein said surfactant is present in an amount from about 0.5% w/w to about 8.7% w/w.

9. The cleaning medium according to claim 4, wherein said protein denaturant is at least one of the following: urea, sodium lauryl sulfate, guanidine hydrochloride, ethylene-diamine tetra-acetic acid, acetic acid, alcohol, aldehydes, tris(2-carboxyethyl)phosphine, or a combination thereof.

10. The cleaning medium according to claim 5, wherein said surfactant is at least one of the following: anionic, cationic, non-ionic, and amphoteric, or a combination thereof.

11. The cleaning medium according to claim 1, wherein said sporicidal composition exhibits at least a 90% reduction of live Clostridium difficile spores within about 10 minutes of application of said cleaning medium to a spore-contaminated surface.

12. The cleaning medium according to claim 10, wherein said sporicidal composition exhibits at least a 90% reduction of live C. difficile spores within about 1 minute of application to a spore-contaminated surface.

13. The cleaning medium according to claim 1, wherein said sporicidal composition further includes up to about 25% w/w of a reducing agent, or up to about 2% w/w of an electron transport accelerator.

14. The cleaning medium according to claim 13, wherein said reducing agent is at least one of the following: sodium thioglycollate, cysteine, zinc, copper, nickel, magnesium, manganese, ferrous iron, sulfite compounds, di-isobutylaluminum hydride, alcohols, sugar alcohols, titanium, amorphous ferrous sulfide, sodium borohydride, lycopene, and vitamin E.

15. The cleaning medium according to claim 13, wherein said electron transport accelerator is one of the following: phenazine methosulfate, phenazine ethosulfate, 7-hydroxycoumarin, vanillin, p-hydroxybenzenesulfonate, and methylene blue.

16. A wiper comprising a substrate sheet; a sporicidal composition disposed over or within at least part of said sheet, said sporicidal composition containing about 0.1-20 w/w % of a germinant agent, about 0.01-75% w/w of a antimicrobial agent, in terms of dry total weight, optionally up to about 10% w/w of a protein denaturant, and up to about 10 w/w % of a surfactant, with water to generate a solution with pH of 3.5-9.5.

17. The wiper according to claim 16, wherein said sporicidal composition further includes up to about 25% w/w of a reducing agent, or up to about 2% w/w of an electron transport accelerator.

18. The wiper according to claim 16, wherein said substrate sheet is formed from either a cellulose-based material or nonwoven web.

19. The wiper according to claim 16, wherein said substrate sheet is formed with a material selected from at least one of the following: a cellulose-based fibrous tissue, a meltblown, hydroknit, coform, or spunlace nonwoven, or a combination of cellulose and synthetic polymer fibers.

20. The wiper according to claim 16, wherein said substrate exhibits a spore population kill rate of at least 1 Log₁₀ within about 10 minutes of when said wiper is applied to a spore-contaminated surface.

21. A cleaning process for killing Clostridium difficile spores, the process comprising: providing a cleaning medium with a sporicidal composition, said sporicidal composition containing about 0.1-20% w/w of a germinant agent, about 0.01-70% w/w of a antimicrobial agent, in terms of dry total weight, and which is admixed with water to generate a solution with a pH of 3.5-8.5; heating said sporicidal composition up to about 45° C.; and applying said cleaning medium to a spore-contaminated surface.

22. The cleaning process according to claim 21, further comprising mixing said heated sporicidal composition.

23. The cleaning process according to claim 21, wherein said mixing is by means of applying ultrasonic energy of up to 500 kHz to said cleaning medium.

24. The cleaning process according to claim 21, wherein said spore-contaminated surface is part of a piece of furniture, table or countertop, floor, wall, bath or lavatory surfaces, bedclothes, and linens.

25. The cleaning process according to claim 21, wherein said spore-contaminated surface is human skin

26. The cleaning process according to claim 21, wherein said spore-contaminated surface is part of a medical device or instrument.

27. The cleaning process according to claim 21, wherein said application of said cleaning medium is by immersion bath, wiping or washing.
